(19) United States
(12) Patent Application Publication
(10) Pub. No.: US 2003/0195901 A1
(43) Pub. Date: Oct. 16, 2003

(54) Database building method for multimedia contents

(75) Inventors: Hyun-doo Shin, Seongnam-city (KR); Yang-lim Choi, Suwon-city (KR); Bangalore S. Manjunath, Santa Barbara, CA (US); Baris Sumengen, Santa Barbara, CA (US); Shawn Newsam, Santa Barbara, CA (US)

Correspondence Address: SUGHRUE MION, PLLC, 2100 PENNSYLVANIA AVENUE, N.W., WASHINGTON, DC, 20037, US

(73) Assignees: SAMSUNG ELECTRONICS CO., LTD.; THE REGENTS OF THE UNIVERSITY OF CALIF.

(21) Appl. No.: 10/419,803

(22) Filed: Apr. 22, 2003

Related U.S. Application Data
(62) Division of application No. 09/822,832, filed on Apr. 2, 2001.
(60) Provisional application No. 60/207,969, filed on May 31, 2000.

(30) Foreign Application Priority Data
Sep. 19, 2000 (KR) 00-54868

(51) Int. Cl. G06F 17/00

(52) U.S. Cl. 707/104.1

(57) ABSTRACT

A database building method for multimedia contents is provided. The database building method for multimedia contents has the steps of (a) accessing an arbitrary site providing multimedia contents through a telecommunications network; (b) calling multimedia contents in by spidering the site; and (c) classifying the multimedia contents data according to the stored addresses and storing them in a predetermined database. Using category information on the corresponding sites, the database building method for multimedia contents according to the present invention semantically classifies multimedia contents and stores them in the corresponding databases. In the database built by the database building method for multimedia contents according to the present invention, multimedia contents which are dispersed on the WWW are well collected and, using category information or URL information, are semantically well classified. Therefore, various method for retrieving multimedia contents can be used so that wanted multimedia contents can be retrieved fast and efficiently.

This application claims the benefit under 35 U.S.C. § 119(e)(1) of and incorporates by reference U.S. Provisional Application No. 60/207,969 filed on May 31, 2000. This application also incorporates by reference Korean Patent Application No. 00-54868 filed on Sep. 19, 2000.

### BACKGROUND OF THE INVENTION

1. Field of the Invention

The present invention relates to classification of multimedia data, and more particularly, to a database building method for multimedia data (hereinafter, referred to as multimedia contents) in which multimedia contents are semantically classified and stored in a predetermined database.

2. Description of the Related Art

On the World Wide Web (WWW), a great many multimedia contents are commonly used. However, retrieval methods are mainly for retrieving text data and fast and efficient retrieval methods for retrieving images, audio data, and motion video data having voices have not been introduced.

As the amount of multimedia data increases these days, a database building method for multimedia contents and a method for providing retrieval services to users using the established database are required.

### SUMMARY OF THE INVENTION

To solve the above problems, it is an object of the present invention to provide a database building method for multimedia contents in which multimedia contents dispersed on the World Wide Web or other telecommunications networks are efficiently collected and stored in one database so that fast retrieval of multimedia contents is enabled.

It is another object to provide a database building apparatus for multimedia contents, using the database building method for multimedia contents.

It is another object to provide a multimedia contents retrieval method for fast retrieving multimedia contents in the database built by the database building method for multimedia contents.

It is another object to provide a multimedia contents retrieval apparatus for using the retrieval method for multimedia contents.

To accomplish the above object of the present invention, there is provided a database building method for multimedia contents, the method including the steps of (a) accessing an arbitrary site providing multimedia contents through a telecommunications network; (b) calling multimedia contents in by spidering the site; and (c) classifying the multimedia contents data according to the stored addresses and storing them in a predetermined database.

Also, the multimedia contents data can be image data.

It is preferable that the addresses are universal resource locators (URLs).

It is preferable that the arbitrary site is selected between a retrieval site or a portal site.

It is preferable that step (b) further includes the sub-steps of (b-1) inputting a search word; (b-2) parsing texts corresponding to the file names of multimedia contents of texts corresponding to sub-categories in hyper text markup language (HTML) web page data having the retrieved results for the input search word; and (b-3) calling multimedia contents data having addresses corresponding to the parsed texts.

It is preferable that before step (b-3) the method further includes (p-b-3-1) visiting the corresponding category when the texts corresponding to the sub-category are parsed in the loaded HTML web page data.

It is preferable that in step (b-2), keywords representing the characteristics of the texts together with the texts corresponding to the sub-categories and the texts corresponding to the file names of the multimedia contents are parsed in the loaded HTML web page data.

It is preferable that after step (b-3) the method further includes the step of (b-4) filtering noise images out among the called images.

It is preferable that step (b-4) further includes the sub-steps of (b-4-1) determining whether or not the pixel number of a called image is equal to or greater than a predetermined threshold value; and (b-4-2) when the pixel number of a called image is equal to or greater than the predetermined threshold value, indexing the corresponding image.

It is preferable that the threshold value is 128.

It is preferable that step (c) further includes the sub-steps of (c-1) decreasing the resolution of the called image; and (c-2) storing the image, of which resolution was decreased, in a predetermined database according to the categorized structure.

Alternatively, it is preferable that in step (c), the URL of the web page storing the called multimedia contents data is stored in a predetermined database using the URL information.

Alternatively, it is preferable that in step (c), at least one of URL information or keyword information together with information on respective images is stored in respective predetermined databases so that keywords can be linked to individual images.

To accomplish another object of the present invention, there is also provided a database building method for multimedia contents, the method including the steps of (a) accessing an arbitrary site providing multimedia contents using a database having a categorized structure; (b) calling multimedia contents data by spidering the site; and (c) storing the called multimedia contents data to a predetermined database, using the categorized structure.

To accomplish another object of the present invention, there is also provided a database building apparatus for multimedia contents, having a web visitor for accessing an arbitrary site providing multimedia contents and calling multimedia contents by spidering the site; and a database for classifying and storing the called multimedia contents data, using the categorized structure of the database of the site or the addresses storing the called multimedia contents data.

To accomplish another object of the present invention, there is also provided a retrieval method for multimedia contents, the method including the steps of (a) receiving keywords corresponding to query images, which are wanted to be searched, from a user; and (b) retrieving images corresponding to keywords in a predetermined database storing keywords corresponding to individual images together with a plurality of images.

To accomplish another object of the present invention, there is also provided a retrieval apparatus for multimedia contents having a database storing a plurality of images and keywords corresponding the individual images; and a retrieval unit for receiving keywords corresponding to the query data, from the user, and retrieving multimedia contents data corresponding to the keywords in the database.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram showing the structure of a database building apparatus for multimedia contents according to an embodiment of the present invention;

FIG. 2 is a flowchart showing the major steps of a database building method for multimedia contents according to an embodiment of the present invention used in the apparatus of FIG. 1;

FIG. 3 is a flowchart showing the major steps of a database building method for multimedia contents according to another embodiment of the present invention used in the apparatus of FIG. 1;

FIG. 4 is a block diagram showing the structure of a multimedia contents retrieval apparatus according to an embodiment of the present invention; and

FIG. 5 is a flowchart showing the major steps of a multimedia contents retrieval method according to an embodiment of the present invention used in the multimedia contents retrieval apparatus of FIG. 4.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

According to the present invention, multimedia contents are semantically classified so that retrieval or browsing can be efficiently done. For example, multimedia contents corresponding to “F-16 fighter” can be classified in a category referred to as “Gulf War”. For this, the merit of the structure categorized in a retrieval site is used. For example, retrieval sites such as Yahoo TM have a categorized structure. For example, a text categorized by “movie” is clicked on, collected information of more detailed sites related to movies in text formats categorized such as “erotic”, “action”, or “human episode” is provided. Also, the addresses of detailed sites related to respective movies can be provided. The classification of such retrieval sites and portal sites are well done semantically. Therefore, the present invention uses the categorized structures of such retrieval sites and portal sites in making a database for multimedia contents.

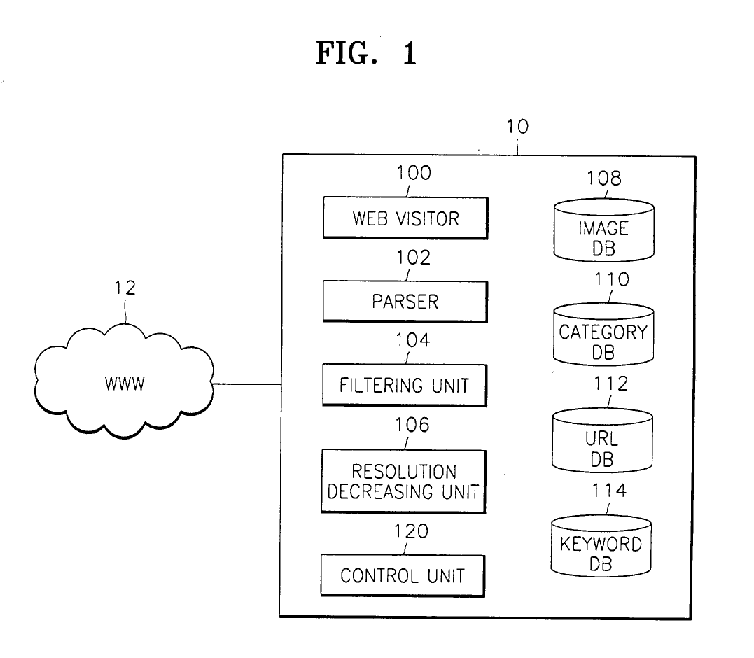

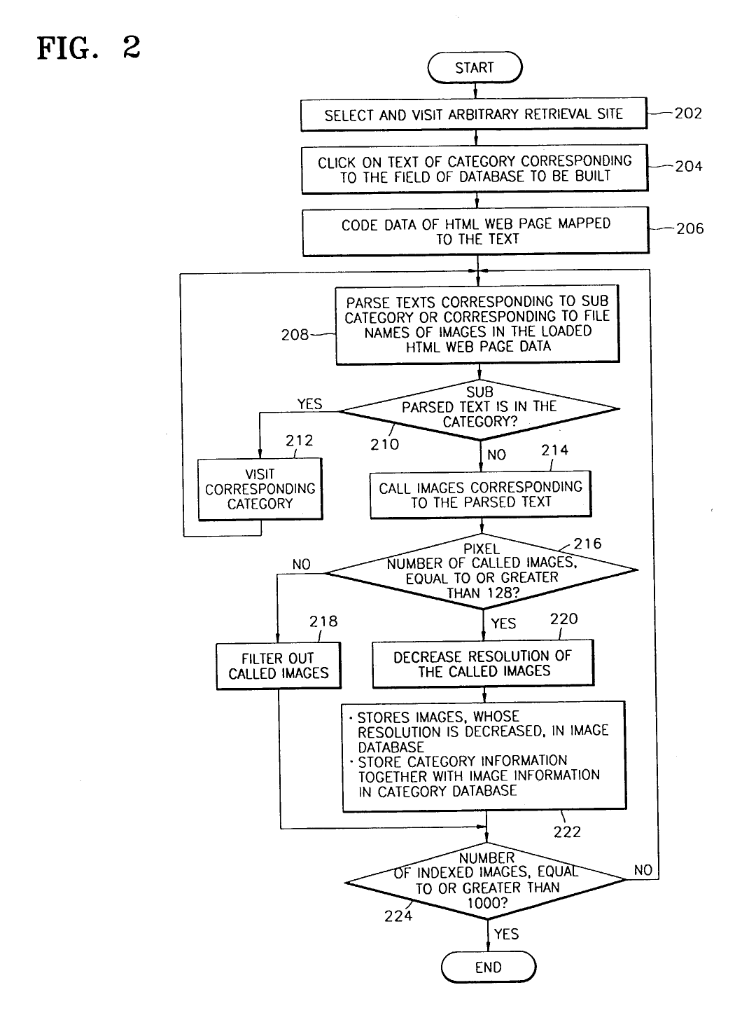

FIG. 1 is a block diagram showing a database building apparatus for multimedia contents according to an embodiment of the present invention. FIG. 2 is a flowchart showing the major steps of a database building method for multimedia contents according to an embodiment of the present invention used in the apparatus of FIG. 1. FIG. 2 will be frequently referred to in the following explanation.

For the present embodiment, an image is taken as an example of the multimedia contents. Referring to FIG. 1, the database building apparatus 10 for multimedia contents according to an embodiment of the present invention is connected to the World Wide Web (WWW) 12, and has a web visitor 100, a parser 102, a filtering unit 104, a resolution decreasing unit 106, an image database 108, a category database 110, a keyword database 114, a universal resource locator (URL) database 112, and a control unit 120.

The operating of the database building apparatus for multimedia contents will now be explained. First, a user selects and visits an arbitrary retrieval site in step 202, and clicks on the text of a category corresponding to the field which the user is interested in on the visiting home page, which consequently is the object of database to be built in step 204. The contents classification of the retrieval site has a categorized structure. Responding to the click by the user, the web visitor 100 loads a hyper text markup language (HTML) web page data mapped from the text in step 206. Next, the parser 102 parses texts corresponding to sub-categories, or multimedia contents, which are texts corresponding to file names of images (in the present embodiment, for example, texts with extensions of “_.JPG”, “_.GIF”, or “_.BMF”), in step 208. Next, it is determined whether or not the parsed text is included in a sub-category in step 210. When it is determined that the parsed text is included in the sub-category, the sub-category is visited in step 212 and step 206 is carried out. Meanwhile, when texts corresponding to the file names of images in the loaded HTML web page data are parsed, the images having the file names corresponding to the parsed texts are called in step 214. By doing so, the web visitor 100 hierarchically visits web pages in the retrieval site and calls images. Such operations are automatically executed and a means referred to as a web robot can be used to implement the operations. That is, it can be said that the web robot visits sites related to the selected URL, by spidering the selected URL and its offspring URL.

Also, it is preferable that the parser 102 parses keywords showing the characteristics of the texts as well as the texts corresponding to the file names of the images in the step 206. Since keywords are nouns in general, it is possible to extract them using already known methods.

Meanwhile, graphics and the like for decorating web sites among called images are regarded as noise and excluded in indexing. Therefore, the called images are filtered and then indexed. In the present embodiment, the filtering unit 104 determines whether or not the number of pixels of a called image is equal to or greater than 128 in step 216. When the pixel number of the called image is less than 128, the called image is determined to be a thumb nail and then is filtered out and not indexed in step 218. When the pixel number of the called image is equal to or greater than 128, the called image is determined not a thumb nail and the resolution decreasing unit 106 decreases the resolution of the image in step 220.

The image of which resolution is decreased is stored in the image database 108, and the identification information of the image stored in the image database 108 and the category information of the visited web page data are stored in the category database 110 in step 222.

Alternatively, the original data can be stored in the database without decreasing its resolution, and, without storing the called image to the database, the URL of the web page having the image can be stored so that the corresponding site can be linked. Also, preferably, in order for keywords to be linked to respective images, keywords corresponding to respective images can be stored together with the information on respective images stored in the image database to the keyword database 114.

The control unit 120 determines whether or not the number of indexed images is equal to or greater than 1,000 in step 224. When the number of indexed images is less than 1,000, a control signal of a “low” level is output, and when the number is equal to or grater than 1,000, a control signal of a “high” level is output. Responding to the “high” level control signal, the parser 102 performs step 208, and responding to the “low” level control signal, it finishes parsing. That is, when the number of indexed images is equal to or greater than 1,000, the visit of a site is finished.

In the database building method for multimedia contents according to the embodiment of the present invention, multimedia contents in the hierarchically visited categories, for example, thumbnail images of which image resolution is decreased, or original images, are semantically classified and stored in the corresponding database using category information of the corresponding sites.

Also, in the database building method for multimedia contents according to the present invention, URLs are used and the directory structures of the sites on the WWW are considered. For example, retrieval sites such as Google™ or Altavista™ provide retrievals based on URLs rather than category information. For example, when a search word “soccer” is input, the addresses of sites related to “soccer” are provided as the search results. Even when these retrieval sites are used, sites having semantically close relations with the corresponding search word are provided.

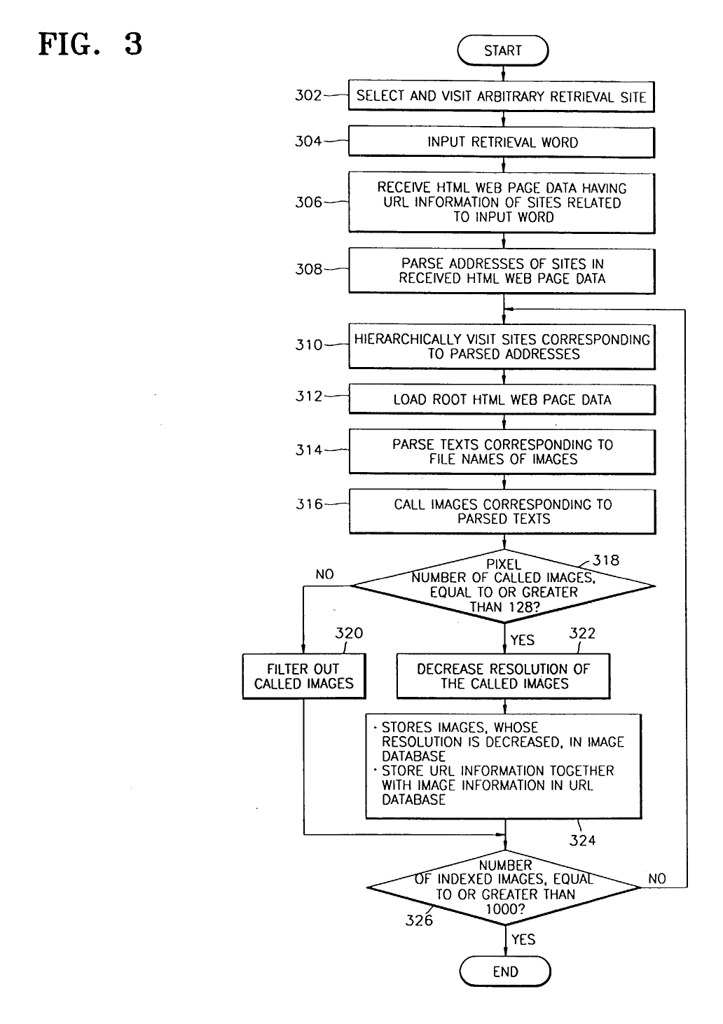

In the database building method for multimedia contents according to another embodiment of the present invention, a structure that enables a semantical search of these retrieval sites is used for building a database for multimedia contents. FIG. 3 is a flowchart showing the major steps of a database building method for multimedia contents according to another embodiment of the present invention used in the apparatus of FIG. 1. Referring to FIG. 3, in the database building method for multimedia contents according to another embodiment of the present invention, first, the web visitor 100 visits an arbitrary retrieval site after selecting the site in step 302. Next, the user inputs a search word corresponding to the field of database which is wanted to be built in step 304. The search word corresponds to the identifier of the multimedia contents to be included in the database. Next, the web visitor 100 receives the addresses of sites related to the input search word, for example, HTML web page data having URL information in step 306.

Next, the parser 102 parses the addresses of the sites in the received HTML web page data in step 308. The web visitor 100 hierarchically visits sites corresponding to parsed addresses in step 310. Then, the web visitor 100 loads root HTML web page data from the visiting retrieval site in step 312. The parser 102 parses multimedia contents in the loaded HTML web page data (for example in the present embodiment, texts corresponding to the names of images, such as texts having extensions of “_.JPG”, “_GIF.”, or “_.BMF”), in step 314. Alternatively, an ALT tag which is used in the HTML language can be used. Since these image names or ALT tags are manually input by a web site author, the characteristics of images, more generally, the characteristics of multimedia contents, are relatively well expressed.

Preferably, the parser 102 also parses keywords representing the characteristics of parsed texts in step 314. Because keywords are generally nouns, it is possible to extract them in an already known method.

Next, the web visitor 100 calls image data corresponding to the parsed text in step 316. Meanwhile, graphics for decorating web sites among the called image data are regarded as noise and must be excluded in indexing. Therefore, the filtering unit 104 filters the called images, filtering noise images out. In the present embodiment, the filtering unit 104 determines whether or not the pixel number of the called image is equal to or greater than 128 in step 318. When the pixel number of the called image is less than 128, the image is determined to be a thumbnail and filtered out to exclude it in indexing in step 320. When the pixel number of the called image is equal to or greater than 128, the resolution decreasing unit 106 determines the called image is not a thumbnail image but an image and decreases the resolution of the image in step 322. The image of which resolution is decreased is stored in the image database 108, and information on respective images stored in the image database 108 together with URL information of the visited web page data are stored in the URL database in step 324.

Alternatively, the original data can be stored in the image database 108 (without decreasing the resolution), and by storing the URL of the web page storing the image, instead of storing the called image in the database, the corresponding site can be linked. Preferably, keywords corresponding to respective images together with information on respective images stored in the image database 108 are stored in the keyword database 114.

The control unit 120 determines whether or not the number of indexed images is equal to or greater than a predetermined number in step 326. When the number of indexed images is less than 1,000, the web visitor 100 loads root HTML web page data from the visiting retrieval site according to the step 310. When the number of indexed images is equal to or greater than 1,000, visit of the site is finished.

Meanwhile, in order to efficiently retrieve images, the characteristics of textures and/or colors can be extracted to be stored in a separate characteristic database (not shown in drawings). These characteristics can be extracted by Gabor filters which has scale and directional coefficients. For example, when a characteristic vector of an input image is calculated by a filter formed by a combination of Gabor filters having 3 kinds of scale coefficients and 4 kinds of directional coefficients, and if average distributions are used for components of the characteristic vector, the characteristic vector can be expressed as shown in equation 1 below:

fₜₑₓₜᵤᵣₑ=[t₁, t₂,t₂, . . . t₂₄, ] (1)

Using the characteristic vectors, images are indexed. In the characteristic database, the characteristic vectors and image information corresponding to the characteristic vectors are stored.

Similarly, it is possible to extract color characteristics to store in a separate characteristic database. Characteristic vectors showing color primitives can be extracted from a color distribution histogram calculated in a CIE LUV color space. For example, if each dimension of 3 dimensional color space is quantized in four levels, it can be expressed as a 64-dimensional color characteristic vectors as shown in equation 2 below:

f_{color}=[c₁, c₂,c₂, . . . c₆₄,] (2)

In the characteristic database, the characteristic vectors and image information corresponding to the characteristic vectors are stored.

In the database building method for multimedia contents according to another embodiment of the present invention, thumbnail images of which image resolution are decreased, or original images, both of which are called from visited categories, are stored in the corresponding database, after being classified semantically using URL information of the corresponding sites. The characteristics of textures and/or colors of called images are stored in a separate database.

In the database building method for multimedia according to the present invention, multimedia contents on the WWW are semantically classified and indexed. Such a database building method for multimedia contents can be applied to multimedia contents such as TV news broadcastings or to shopping items using online multimedia expression.

Though building a database of images is exemplified in the above embodiments, the present invention can be applied to various multimedia contents such as voice clip, and motion video clip having voices. That is, the present invention is not restricted to the above-described embodiments, and the scope of the present invention is determined by the accompanying claims.

In the database built by the database building method for multimedia contents according to the present invention described above, multimedia contents dispersed on the WWW are well collected, and the multimedia contents acre semantically well classified, using category information or URL information. Therefore, various retrieval method for multimedia can be used to efficiently retrieve wanted multimedia contents. Data which is similar to query data of multimedia data can be efficiently retrieved, particularly when using the method for retrieving multimedia contents according to the present invention.

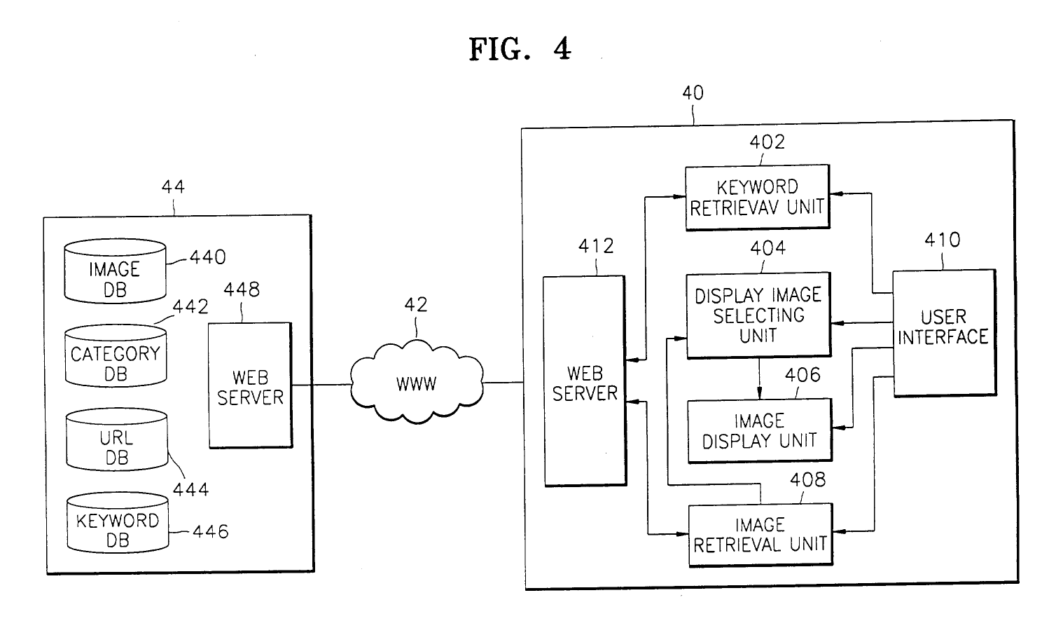

FIG. 4 is a block diagram showing the structure of a multimedia contents retrieval apparatus according to an embodiment of the present invention. Referring to FIG. 4, the multimedia contents retrieval apparatus according to an embodiment of the present invention is linked to a server 44 for providing an image retrieval service through the WWW 42, a kind of service provided through the Internet.

The multimedia contents retrieval apparatus has a keyword retrieval unit 402, a display image selecting unit 404, an image display unit 406, an image retrieval unit 408, a user interface 410, and a web server 412 for communicating with the WWW 42.

The server 44 has databases built by the database building method for multimedia contents explained referring to FIGS. 2 and 3, that is, an image database 440, a category database 442, a URL database 444, and a keyword database 446, Also, the server 44 has a web server 448 for communicating with the WWW 42.

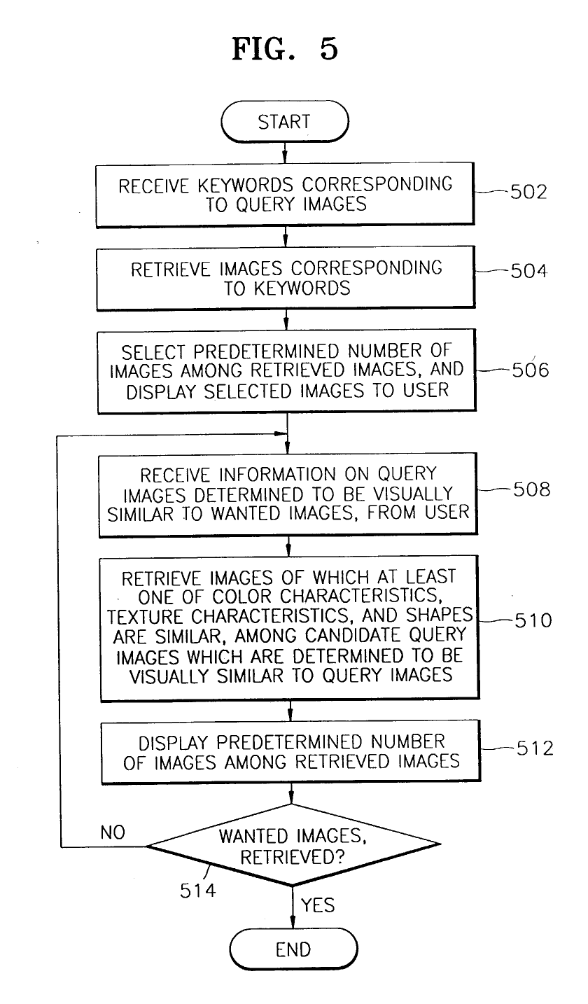

FIG. 5 is a flowchart showing the major steps of a multimedia contents retrieval method according to an embodiment of the present invention used in the multimedia contents retrieval apparatus of FIG. 4. FIG. 5 is referred to from time to time. In the present embodiment, an image is taken as an example of the multimedia contents, and it is assumed that databases are built using the database building method for multimedia contents according to the embodiment of the present invention explained referring to FIG. 2.

Referring to FIG. 5, first, a keyword corresponding to a query image from the user is received in step 502. First, when a user wants to retrieve “shoe”, which has a certain shape, with a query image, the user operates a recording medium, which stores program codes performing the multimedia contents retrieval method according to the present invention, in a computer, and inputs the keyword “shoe” to a retrieval keyword space on the operating screen displayed on the monitor of the user.

Next, the keyword retrieval unit 402 retrieves words, which are identical to the input keyword, in the keyword database 446 of the server 44 through the web server 412. When the identical word is retrieved, the image linked to the retrieved word is called in from the image database 440. By doing so, images corresponding to the input keyword are retrieved in step 504.

Meanwhile, since there are a lot of images in the database, and the retrieved images obtained by using only a keyword in a voluminous database could include those images which are not visually similar to the wanted image, it is almost impossible to retrieve the wanted image with one retrieval using only a keyword. Therefore, it is preferable that the user checks with naked eyes some images among the retrieved images and selects similar images to feed the selected images back to the image retrieval unit 408 so that retrieval can be executed again.

For this, the display image selecting unit 404 selects predetermined number of images among the images retrieved in the step 504 and the image display unit 406 displays the predetermined number of selected images for the user in step 506.

Next, watching the displayed images with naked eyes, the user selects one or more images, which are similar to the image the user wants to find, and determines those images as query images and provides information on them. In the present embodiment, responding to user's input, the user interface 410 selects a plurality of shoe shape images and provides selecting information. By doing so, the image retrieval unit 408 receives information on candidate query images, which are decided to be visually similar to the wanted image, from the user in step 508.

Next, the image retrieval unit 408 retrieves images which are similar to at least one among the color characteristic, the texture characteristic and the shape, among candidate query images that are determined to be visually similar to the query image, in the image database in step 510.

In order to determine whether or not two images, that is, the query image and the retrieved image, are visually similar, similarity can be obtained by the calculated difference of characteristic vectors of the two images. In the present embodiment, it is assumed that the characteristic vectors of images are stored in a characteristic database (not shown in drawings). When k is the length of the texture vector, the difference between characteristics of textures of two images i and j can be obtained by the following equation 1:

$${d}_{texture} ( i , j ) = {\sum }_{k = 1}^{24} \vert {t}_{k}^{( i )} - {t}_{k}^{( j )} \vert . \qquad ( 1 )$$

Also, when k is the length of the color vector, the difference between characteristics of colors of two images i and j can be obtained by calculating the Euclidean distance of the two characteristic vectors using equation 2 below:

$${d}_{color} ( i , j ) = {( {\sum }_{k = 1}^{64} {( {c}_{k}^{( i )} - {c}_{k}^{( j )} )}^{2} )}^{1 / 2} \qquad ( 2 )$$

The retrieved image is determined to be the image which has the characteristic vector of the least difference to the characteristic vector of the given query image.

When an image to be retrieved is an original image, the retrieved image is provided to the user as it is. When an image to be retrieved is a thumbnail image, the URL of the retrieved image, that is, the URL corresponding to the original image of the thumbnail image is used to call the original image after the site having the corresponding URL is connected through the Internet. The original image is then provided to the user. At this time, the URL information can be stored together with the thumbnail image in the image database 422.

In retrieving based on contents, the user selects a set R of relevant query images. The relative weighted values of characteristics of colors and textures are determined depending on how tightly such sets of images are collected in a color space. That is, when |R| is the number of images in the query set, the weighted values are obtained by equations 3 and 4 below:

$$\begin{matrix}{\overline{d}}_{texture} = \frac{1}{\vert R \vert} {\sum }_{i , j ∈ R}^{} {d}_{texture} ( i , j ) & ( 3 ) \\ {\overline{d}}_{color} = \frac{1}{\vert R \vert} {\sum }_{i , j ∈ R}^{} {d}_{color} ( i , j ) & ( 4 )\end{matrix}$$

Next, when ε is a predetermined small value for preventing any one characteristic from being extremely prominent, the weighted value can be obtained through the following equations 5 and 6:

$$\begin{matrix}{w}_{texture} = \frac{1}{{\overline{d}}_{texture} + ϵ} & ( 5 ) \\ {w}_{color} = \frac{1}{{\overline{d}}_{color} + ϵ} & ( 6 )\end{matrix}$$

When N is a predetermined positive number, N nearest neighbors can be obtained by calculating equation 7 below:

d(●,●)=wₜₑₓₜᵤᵣₑdₜₑₓₜᵤᵣₑ(●,●)+w_{color}d_{color}(●,●) (7)

Generally, a query is specified by a single pair of a texture characteristic vector and a color characteristic vector. Therefore, in the present embodiment, when a plurality of query images are selected, the average of the characteristic vector and the color characteristic vector is used. That is, the values are obtained by equations 8 and 9 below:

$$\begin{matrix}{\overline{f}}_{texture} = \frac{1}{\vert {R}_{q} \vert} {\sum }_{i ∈ R}^{} {f}_{texture}^{( i )} & ( 8 ) \\ {\overline{f}}_{color} = \frac{1}{\vert {R}_{q} \vert} {\sum }_{i ∈ R}^{} {f}_{color}^{( i )} & ( 9 )\end{matrix}$$

Retrieval based on contents can be generalized as follows. In a single query image using characteristic vectors fₜₑₓₜᵤᵣₑ and f_{color}, first, when i is 1, . . . , N/2 and i≦j, it is assumed that following conditions 10 and 11 are satisfied:

$$\begin{matrix}{d}_{texture} ( {f}_{texture} , {s}_{texture}^{( i )} ) \leq {d}_{texture} ( {f}_{texture} , {s}_{texture}^{( j )} ) \\ ( Here , x ∉ {S}_{texture} ) & ( 10 ) \\ {d}_{texture} ( {f}_{texture} , {s}_{texture}^{( N / 2 )} ) \leq {d}_{texture} ( {f}_{texture} , {x}_{texture}^{( j )} ) & ( 11 )\end{matrix}$$

Then, the following equation 12 can be used:

Sₜₑₓₜᵤᵣₑ={s⁽ⁱ⁾} (12)

Second, when i is 1, . . . , N/2 and i≦j, it is assumed that following conditions 13 and 14 are satisfied:

$$\begin{matrix}{d}_{color} ( {f}_{color} , {s}_{color}^{( i )} ) \leq {d}_{color} ( {f}_{color} , {s}_{color}^{( j )} ) \\ ( Here , x ∉ {S}_{color} ) & ( 13 ) \\ {d}_{color} ( {f}_{color} , {s}_{color}^{( N / 2 )} ) \leq {d}_{color} ( {f}_{color} , {x}_{color}^{( j )} ) & ( 14 )\end{matrix}$$

Then, the following equation 15 can be used:

s_{color}={s⁽ⁱ⁾} (15)

Also, in a plurality of query images having \overline{f}ₜₑₓₜᵤᵣₑ and \overline{f}_{color}, when i is 1, . . . , N and i≦j, it is assumed that following conditions 16 and 17 are satisfied:

$$\begin{matrix}d ( ( {\overline{f}}_{texture} , {\overline{f}}_{color} ) , ( {s}_{texture}^{( j )} , {s}_{color}^{( j )} ) ) \leq d ( ( {\overline{f}}_{texture} , {\overline{f}}_{color} ) , ( {s}_{texture}^{( j )} , {s}_{color}^{( j )} ) ) \\ ( Here , x ∉ {S}_{texture} ) & ( 16 ) \\ d ( ( {\overline{f}}_{texture} , {\overline{f}}_{color} ) , ( {\overline{s}}_{texture}^{( N )} , {\overline{s}}_{color}^{( N )} ) ) \leq d ( ( {\overline{f}}_{texture} , {\overline{f}}_{color} ) , ( {x}_{texture} , {x}_{color} ) ) & ( 17 )\end{matrix}$$

Then, the following equation 18 can be used:

S={s⁽ⁱ⁾} (18)

Next, the display image selecting unit 404 again selects predetermined number images among the retrieved images of which at least one of color characteristics, texture characteristics, and shapes are similar, and the image display unit 406 displays the predetermined number of selected images to the user in step 512. Here, it is preferable that the scope of retrieval is limited within the category of the query image and the neighboring categories.

When the database is built according to the database building method for multimedia contents according to the second embodiment of the present invention explained referring to FIG. 4, it is preferable that the scope of retrieval is limited within the query image URL and neighboring URLs. The object image of retrieval can be the original image or the thumbnail image which is obtained by decreasing the resolution of the original image. When the object image of retrieval is the original image, retrieval can be done more accurately, but, depending on the amount of data and the system performance, retrieval time can be extended. When the object image of retrieval is the thumbnail image, accuracy is lower but retrieval time can be shortened. Therefore a database can be managed appropriately.

Responding to the user's input, the user interface 410 selects one or more images which are determined to be similar to the wanted image by the user when the user views the displayed images with naked eyes, and provides information on the images which are determined to be visually similar to the query image. By doing so, the image retrieval unit 408 again receives information on the images which are determined to be visually similar to the query image, from the user. The images which are received again are regarded as candidate query images. Next, the image retrieval unit 408 again retrieves those images, of which at least one among color characteristics, texture characteristics, and shapes, are determined to be visually similar to the query image, in the image database 422. That is, it is determined whether or not the wanted image is retrieved in step 514, and when the wanted image is not retrieved, steps 508 through 512 are repeatedly performed. Here, it is preferable that the scope of retrieval is limited within the category of the query image and neighboring categories.

The multimedia contents retrieval method enables fast retrieval of wanted images in the database collectively storing multimedia contents.

The database building method for multimedia contents and the retrieval method can be written as a program operating in a personal computer or a server-class computer. The program codes and code segments forming the program can be easily drawn by computer programs in the field. The program can be stored in a computer readable recording medium. The recording medium includes a magnetic recording medium, an optical recording medium and a radio wave medium.

As described above, using category information on the corresponding sites, the database building method for multimedia contents according to the present invention semantically classifies multimedia contents and stores them in the corresponding databases. In the database built by the database building method for multimedia contents according to the present invention, multimedia contents which are dispersed on the WWW are well collected and, using category information or URL information, are semantically well classified. Therefore, various methods for retrieving multimedia contents can be used so that wanted multimedia contents can be retrieved fast and efficiently.

What is claimed is:

1. A database building method for multimedia contents, the method comprising the steps of:
(a) accessing an arbitrary site providing multimedia contents through a telecommunications network;
(b) calling multimedia contents in by spidering the site; and
(c) classifying the multimedia contents data according to stored addresses and storing the multimedia contents data in a predetermined database.

2. The database building method of claim 1, wherein the multimedia contents data is image data.

3. The database building method of claim 1, wherein the stored addresses are universal resource locators (URLs).

4. The database building method of claim 1, wherein the arbitrary site is selected between a retrieval site or a portal site.

5. The database building method of claim 4, wherein step (b) further comprises the sub-steps of:
(b-1) inputting a search word;
(b-2) parsing texts corresponding to file names of multimedia contents or texts corresponding to sub-categories in hyper text markup language (HTML) web page data having retrieved results from the input search word; and
(b-3) calling multimedia contents data having addresses corresponding to the parsed texts.

6. The database building method of claim 5, before step (b-3) further comprising:
(p-b-3-1) visiting a corresponding category when the texts corresponding to the sub-category are parsed in a loaded HTML web page data.

7. The database building method of claim 5, wherein in thestep (b-2), keywords representing characteristics of the texts corresponding to the sub-categories together with the texts corresponding to the file names of the multimedia contents are parsed in a loaded HTML web page data.

8. The database building method of claim 5, wherein the called multimedia contents data is called image data.

9. The database building method of claim 8, further comprising the step of:
(b-4) after the step (b-3) filtering noise images out of the called image data to get a filtered image.

10. The database building method of claim 9, wherein step (b-4) further comprises the sub-steps of:
(b-4-1) determining whether or not a pixel number of the filtered image is equal to or greater than a predetermined threshold value; and
(b-4-2) indexing the corresponding image when the pixel number of the filtered image is equal to or greater than the predetermined threshold value.

11. The database building method of claim 10, wherein the predetermined threshold value is 128.

12. The database building method of claim 4, wherein step (c) further comprises the sub-steps of:
(c-1) decreasing resolution of the called multimedia contents if the multimedia content is an image; and
(c-2) storing the image of step (c-1), of which resolution was decreased in step (c-1), in the predetermined database according to a categorized structure.

13. The database building method of claim 3, wherein in step (c), the URL of a web page storing the called multimedia contents data is stored in the predetermined database using the URL information.

14. The database building method of claim 7, wherein in step (c), at least one of URL information or keyword information together with information on respective images is stored in respective predetermined databases so that keywords can be linked to individual images.

15. A database building method for multimedia contents, the method comprising the steps of:
(a) accessing an arbitrary site providing multimedia contents using a database having a categorized structure;
(b) calling multimedia contents data by spidering the arbitrary site; and
(c) storing the called multimedia contents data to a predetermined database, using the categorized structure.

16. The database building method of claim 15, wherein the called multimedia contents data is called image data.

17. The database building method of claim 15, wherein step (b) further comprises the sub-steps of:
(b-1) loading root HTML web page data from the arbitrary site;
(b-2) parsing texts corresponding to a sub-category or corresponding to file names of multimedia contents in the loaded HTML web page data; and
(b-3) calling multimedia contents data of addresses corresponding to the parsed texts.

18. The database building method of claim 17, further comprising the step of:
(p-b-3-1) before the step (b-3), visiting the corresponding sub-category of step (b-2) when texts corresponding to the sub-category are parsed in the loaded HTML web page data.

19. The database building method of claim 17, wherein in step (b-2), keywords representing characteristics of the texts corresponding to the sub-category or the texts corresponding to the file names of multimedia contents are parsed.

20. The database building method of claim 16 further comprising the step of:
(b-4) after step (b-3), filtering noise images out of the called image data to get filtered images.

21. The database building method of claim 20, wherein step (b-4) further comprises the sub-steps of:
(b-4-1) determining whether or not a pixel number of the filtered images is equal to or greater than a predetermined threshold value; and
(b-4-2) when the pixel number of the filtered images is equal to or greater than the predetermined threshold value, indexing the filtered images.

22. The database building method of claim 21, wherein the predetermined threshold value is 128.

23. The database building method of claim 16, wherein step (c) further comprises the sub-steps of:
(c-1) decreasing resolution of the called image data; and
(c-2) storing the called image data, of which resolution was decreased, in the predetermined database, using the categorized structure.

24. The database building method of claim 15, wherein in step (c), a URL of a web page storing the called multimedia contents data is stored in the predetermined database, using the categorized structure.

25. The database building method of claim 15, wherein in step (c), at least one of category information and keyword information, together with information on individual images, is stored in respective predetermined databases.

26. A database building apparatus for multimedia contents, comprising:
a web visitor for accessing an arbitrary site providing multimedia contents and calling the multimedia contents by spidering the arbitrary site; and
a database for classifying and storing the called multimedia contents using a categorized structure of a database of the arbitrary site or using addresses storing the called multimedia contents data.

27. The database building apparatus of claim 26, wherein the web visitor selects and visits an arbitrary retrieval site; loads root HTML web page data from the arbitrary retrieval site; visits a corresponding sub-category after texts corresponding to the sub-category are parsed in the loaded HTML web page data; and hierarchically visits other web pages or sites linked to the loaded HTML web page data and having addresses corresponding to the parsed texts corresponding to the sub-category.

28. The database building apparatus of claim 26, wherein the called multimedia contents is called image data.

29. The database building apparatus of claim 26, further comprising:
a filtering unit for filtering noise images out of the called image data to get filtered image.

30. The database building apparatus of claim 29, wherein the filtering unit determines whether or not a pixel number of the filtered image is equal to or greater than a predetermined threshold value, and when the pixel number of the filtered image is less than the predetermined threshold value, filters out the filtered image.

31. The database building apparatus of claim 28, wherein the parser parses keywords representing characteristics of a file name of the multimedia contents.

32. The database building apparatus of claim 30, further comprising:
a resolution decreasing unit for decreasing resolution of the filtered image.

33. The database building apparatus of claim 26, further comprising:
a control unit for outputting a control signal, wherein it is determined whether or not a number of indexed multimedia contents is equal to or greater than a predetermined number, and when the number of indexed multimedia contents is equal to or greater than the predetermined number, the control signal has a first predetermined logic level and when the number of indexed multimedia contents is less than the predetermined number, the control signal has a second predetermined logic level.

34. The database building apparatus of claim 33, wherein responding to the control signal having the first predetermined logic level, a parser finishes parsing, and responding to the control signal having the second predetermined logic level, the parser parses texts corresponding to the addresses of other web pages or sites linked to HTML web page data.

35. The database building apparatus of claim 26, wherein the database further comprises:
a first database for storing category information;
a second database for storing URL information;
a third database for storing lists of keywords; and
a fourth database for storing multimedia contents indexed by information stored in the first database, second database, and third database.

36. The database building apparatus of claim 35, wherein the fourth database stores information on URLs storing indexed multimedia contents using information stored in the first database, second database, and third database.

37. The database building apparatus of claim 35, wherein multimedia contents stored in the fourth database are thumbnails of original images which are generated by decreasing resolution of the original images.

38. A retrieval method for multimedia contents, the method comprising the steps of:
(a) receiving keywords from a user corresponding to query images that a user wants to have searched; and
(b) retrieving images corresponding to keywords in a predetermined database and storing keywords corresponding to individual images together with a plurality of images.

39. The retrieval method of claim 38, wherein the multimedia contents are images, and further comprising the steps of:
(c-1) displaying the retrieved images to the user;
(c-2) receiving information from the user on the retrieved images which are determined to be visually similar to the query images; and
(c-3) retrieving images in the database, of which at least one among color characteristics, texture characteristics, and shapes, are similar, among the images which are determined to be visually similar to the query images.

40. The retrieval method of claim 39, wherein the plurality of images are thumbnail images of original images which are obtained by decreasing resolution of the original images.

41. The retrieval method of claim 38, wherein the predetermined database stores the retrieved images by category, and step (b) further comprises the sub-steps of:
(b-1) retrieving a category representing the query image; and
(b-2) retrieving images, of which at least one among color characteristics, texture characteristics, and shapes, are similar, among the images which are determined to be visually similar to the query images among the images in the retrieved category of step (b-1).

42. The retrieval method of claim 38, wherein the step (b) further comprises the sub-steps of:
(b-1) retrieving words identical to input keywords in an entire keyword database; and
(b-2) retrieving images corresponding to the input keywords by calling the images linked to the retrieved words from an image database, when the retrieved words are identical to the input keywords.

43. The retrieval method of claim 42, wherein after the sub-step (b-2) step (b) further comprises the sub-steps of:
(b-3) displaying a second predetermined number of selected images to the user, after selecting a first predetermined number of the retrieved images;
(b-4) receiving information from the user on query images which are determined to be visually similar to wanted images; and
(b-5) retrieving images in the image database, of which at least one among color characteristics, texture characteristics, and shapes, are similar, among the retrieved images which are determined to be visually similar to the query images.

44. The retrieval method of claim 38, wherein retrieval is limited to a category of the query images and neighboring categories.

45. The retrieval method of claim 38, wherein retrieval is limited to a URL of the query images and neighboring URLs.

46. A retrieval apparatus for multimedia contents comprising:
a database for storing a plurality of images and keywords corresponding to individual images; and
a retrieval unit for receiving input keywords corresponding to the query data from a user, and retrieving multimedia contents data corresponding to the keywords in the database.

47. The retrieval apparatus of claim 46, wherein the retrieval unit comprises:
a keyword retrieval unit for retrieving words from the database which are identical to the input keywords inputted by the user and retrieving multimedia contents corresponding to the input keywords, by calling multimedia contents linked to the retrieved words after the words identical to the input keywords are retrieved.

48. The retrieval apparatus of claim 46, wherein the multimedia contents are images, and the retrieval unit further comprises:
an image retrieval unit for receiving information on query images from the user, which are determined to be visually similar to wanted images,and retrieving images in the image database, of which at least one among color characteristics, texture characteristics, and shapes, are similar, among the retrieved images which are determined to be visually similar to the query images.

49. The retrieval apparatus of claim 46, wherein the multimedia contents are images and the retrieval apparatus further comprises:
a user interface for selecting images which the user wants to retrieve, in response to the user's input, and providing selection information;
a display image selecting unit for selecting a predetermined number of selected images; and
an image display unit for displaying the predetermined number of selected images to the user.

50. The retrieval apparatus of claim 46, wherein the database comprises at least one of:
an image database for storing individual images; and
a keyword database for storing keywords corresponding to individual images together with information on individual images stored in the image database.

51. The retrieval apparatus of claim 46, wherein the database comprises at least one of:
an image database for storing individual images; and
a category database for storing category information of data of a visiting web page together with information on individual images stored in the image database.
